(19) United States
(12) Patent Application Publication
(10) Pub. No.: US 2005/0236823 A1
(43) Pub. Date: Oct. 27, 2005

(54) Gas bag

(75) Inventor: Dominik Schuetz, Waldaschaff (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/112,265

(22) Filed: Apr. 22, 2005

(30) Foreign Application Priority Data
Apr. 27, 2004 (DE) 20 2004 006 655.6

(51) Int. Cl. B60R 21/16

(52) U.S. Cl. 280/743.2

(57) ABSTRACT

A gas bag for a vehicle occupant restraint system has an upper side and a bottom side, the upper side and the bottom side being connected with each other along a peripheral fastening, and a first and a second limiting strap device arranged inside the gas bag. The limiting strap devices each have a central part and several end sections. The central part of a first limiting strap device is connected with the upper side of the gas bag, the central part of a second limiting strap device is connected with the bottom side of the gas bag and the end sections of the limiting strap devices are connected to the peripheral fastening. The limiting strap devices are coordinated with respect to length and arrangement, so that the gas bag in a fully inflated state is constricted by the limiting strap devices in a region of the peripheral fastening.

### TECHNICAL FIELD

The invention relates to a gas bag.

### BACKGROUND OF THE INVENTION

Gas bags for vehicle occupant restraint systems having an upper side and a bottom side which are connected with each other along a peripheral fastening are used, for example, in driver's gas bag modules in which the folded gas bag is arranged in a steering wheel and, in case of an accident, inflate between the driver and the steering wheel, but they can also be used in other areas inside the vehicle.

In order to delimit the depth of the gas bag in the inflated state, it is known to arrange so-called limiting straps inside the gas bag, which limit the expansion of the gas bag in the direction towards a vehicle occupant. These limiting straps are connected to the fabric layers of the upper side which faces the occupant, and the bottom side which contains an inflation opening, generally by sewing. The peripheral fastening is often realized likewise by one or more seams running along the periphery of the bottom side or the upper side, but can also be formed by gluing, for example.

A critical point is the stress of the peripheral fastening, especially at the moment in which the vehicle occupant immerses into the gas bag and the stress suddenly increases. In case of using a peripheral seam, it must be avoided that gas which contains particles emerges, if the seam widens. In addition, of course the requirements concerning the strength of the peripheral fastening are very high on account of the high stresses acting thereon.

### BRIEF SUMMARY OF THE INVENTION

It is an object of the invention to reduce the stress on the peripheral fastening of a gas bag.

In a first way, this is achieved by a gas bag for a vehicle occupant restraint system having an upper side and a bottom side, the upper side and the bottom side being connected with each other along a peripheral fastening, and a first and a second limiting strap device arranged inside the gas bag. The limiting strap devices each have a central part and several end sections. The central part of a first limiting strap device is connected with the upper side of the gas bag, the central part of a second limiting strap device is connected with the bottom side of the gas bag, and the end sections of the limiting strap devices are connected to the peripheral fastening. The limiting strap devices are coordinated with respect to length and arrangement, so that the gas bag in a fully inflated state is constricted by the limiting strap devices in a region of the peripheral fastening.

The limiting strap devices receive part of the load which acts on the outer wall of the gas bag, so that there is not only a first force acting on the peripheral fastening, which strives to distance the upper side and the bottom side from each other, but also a second force acting into the interior of the gas bag, which leads to a reduction of the first force.

As the stress on the peripheral fastening by the first force is reduced, there will be no widening of the seam stitches in the fabric with the usage of a seam as peripheral fastening, so that the particle emission through the seam is reduced.

The production of the peripheral fastening and the fastening of limiting straps on the walls of the gas bag is a complex activity which must be carried out with a high degree of accuracy. Generally, the gas bag is sewn “inside out”, because all components to be fastened are accessible from the exterior in that case. After completion of the sewing work, the gas bag is turned inside out using its inflation opening situated in the bottom side, and is thus “brought right side up”. This production method is very work-intensive and time-consuming, but offers the advantage that all the seams and fabric edges are arranged inside the gas bag, whereby their contact with the impacting vehicle occupant is avoided.

For the gas bag according to the invention, it can be achieved that in the region of the peripheral fastening an indentation is formed which is so deep, that in radial direction, regions of the upper side project further than the peripheral fastening, because the end sections of the limiting strap devices, connected to the peripheral fastening, draw the peripheral fastening towards the interior of the gas bag. This has the positive effect, that the gas bag can be sewn “right side up”, saving time, so that with the gas bag being inflated both the peripheral fastening and also the edges of the upper side and the bottom side are arranged on the exterior of the gas bag. Nevertheless, a vehicle occupant can not get in contact with these elements, because the gas bag is so constricted in this region, owing to the action of the limiting strap devices, that in case of the gas bag being inflated, they are covered by regions of the upper side and possibly the bottom side.

The invention can also be used, however, in gas bags which are sewn “inside out” and then brought “right side up”.

A further problem occurs with gas bags when the vehicle occupant immerses into the gas bag. At that moment, the gas bag is compressed and the internal pressure suddenly increases. In order to reduce the internal pressure, outflow openings can be provided in the gas bag, through which a portion of the gas is able to escape into the environment. However, outflow openings bring other obvious disadvantages with them, whether they are either constantly open, so that a greater amount of gas has to be planned, or complicated opening devices have to be provided, which affect the release of the outflow opening as a function of load.

The scissor-like arrangement of the limiting elements inside the gas bag according to the invention has the effect however, that with the vehicle occupant hitting the upper side of the gas bag, the lateral expansion of the gas bag is increased in the plane of the peripheral fastening, i.e. in radial direction. Owing to the alteration in shape, there is a smaller volume reduction than in conventional gas bags, which reduces internal pressure fluctuations with the vehicle occupant's immersion into the gas bag. In this way, the area of the outflow openings can be reduced or outflow openings can be dispensed with entirely.

The most uniform stressing of the peripheral fastening is achieved when the end sections of the two limiting strap devices engage on the peripheral fastening, staggered peripherally to each other. Preferably, the end sections of the limiting strap devices are arranged with peripherally identical angular distances on the peripheral fastening.

The first and/or the second limiting strap device can be formed in a single piece, respectively, e.g. as cut-outs from fabric pieces, so that the first and/or the second limiting strap device each consist of a single fabric layer.

The reduction of the stress onto the peripheral fastening can also be achieved in a second way. For this, a gas bag for a vehicle occupant restraint system, with an upper side and a bottom side which are connected with each other along a peripheral fastening has a reinforcing element, which is arranged in the region of the peripheral fastening and runs peripherally around the gas bag. A peripheral length of the reinforcing element is shorter than the peripheral length of the peripheral fastening, so that the gas bag, in the fully inflated state, is constricted by the reinforcing element in the region of the peripheral fastening. Therefore, in the fully inflated state, also including the moment in which a vehicle occupant plunges into the gas bag, a large part of the stress is received by the reinforcing element instead of the peripheral fastening, so that the peripheral fastening is relieved of stress. In this case, the peripheral fastening can also be constructed to be weaker than in conventional gas bags.

In case of using a seam as peripheral fastening, a widening of the seam stitches and hence a particle emission from the gas bag is also avoided here.

In this case, preferably likewise in the region of the peripheral fastening, an indentation is formed, which is so deep that in radial direction regions of the upper side project further than the peripheral fastening. As already described above, the peripheral fastening is covered by the upper side and possibly also the bottom side of the gas bag as a result of the indentation. If a gas bag is used which is sewn “on the right side”, the vehicle occupant is accordingly protected from fabric edges or seams, although these lie on the outer side of the gas bag. Hereby, the costly manufacture of sewing the gas bag “inside out” and then turning it inside out to the “right side” can be avoided.

Of course, the invention can also be used for gas bags which are sewn conventionally “inside out” and brought “right side up”.

The reinforcing element can be arranged inside the gas bag or on an outer side of the gas bag.

Preferably, the reinforcing element is a cord or a band.

### BRIEF DESCRIPTION OF THE DRAWINGS

FIG. 1 shows a sectional view of a gas bag according to the invention in accordance with a first embodiment in a fully inflated state;

FIG. 2 shows a sectional view of the gas bag of FIG. 1 at the moment of immersion of a vehicle occupant;

FIG. 3 shows a top view of the gas bag of FIG. 1, viewed from a vehicle occupant, the upper side not being shown;

FIG. 4 shows a variant of the gas bag of FIG. 1 in a sectional view;

FIG. 5 shows a top view onto a gas bag according to the invention in accordance with a second embodiment, viewed from a vehicle occupant, the upper side of the gas bag not being shown;

FIG. 6 shows a diagrammatic sectional view of a gas bag module, showing different variants of a gas bag according to the invention in the right and left half respectively; and

FIG. 7 shows another variant of the gas bag of FIG. 5 in a sectional view.

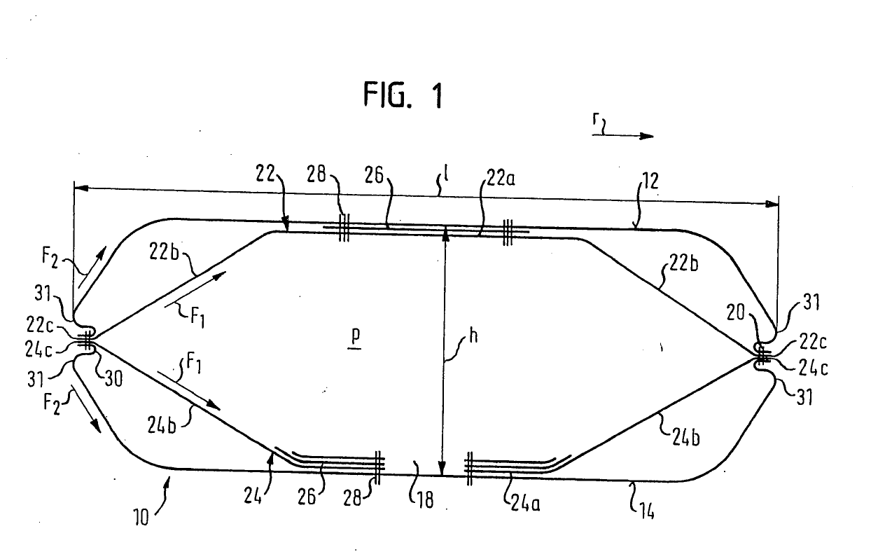

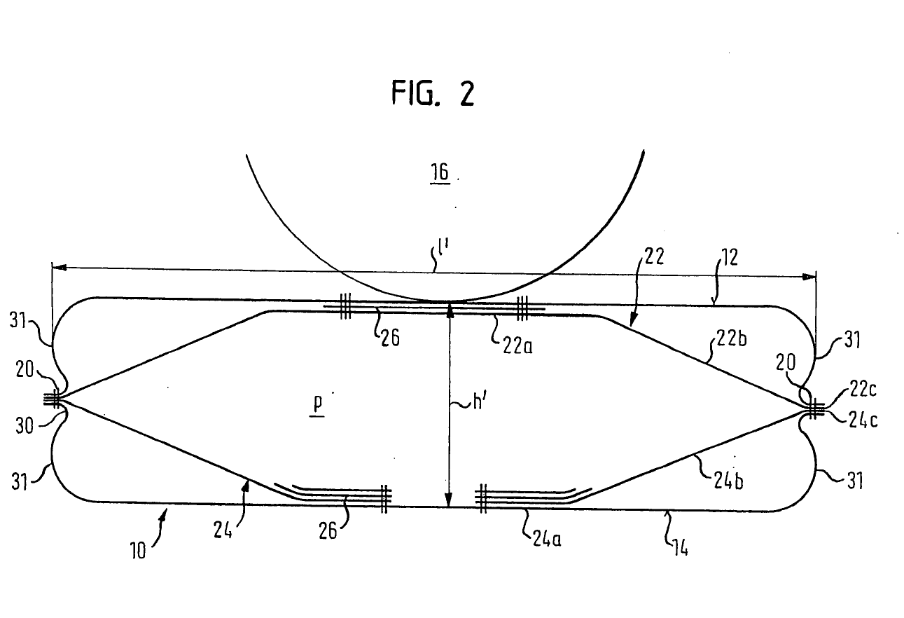

FIG. 1 shows a fully inflated gas bag 10 according to a first embodiment, having two substantially circular fabric layers which form an upper side 12 and a bottom side 14 of the gas bag 10. The upper side 12 faces a vehicle occupant 16 who is shown diagrammatically in FIG. 2. In the bottom side 14 an inflation opening 18 is provided, into which in a conventional manner a gas generator is inserted, not shown here, which is part of a gas bag module. The bottom side 14 is fastened to a vehicle via the gas bag module.

The upper side 12 and bottom side 14 are connected along their peripheral edge by a peripheral fastening 20. This peripheral fastening 20 can be, for example, a seam, also a multiple seam, or a glued connection.

Inside the gas bag 10, a first and a second limiting strap device 22, 24 are arranged, each cut out in one piece from a fabric layer. Each of the limiting strap devices 22, 24 has a central part 22a, 24a, the central part 22a of the first limiting strap device 22 being fastened in a centre region of the upper side 12 and the central part 24a of the second limiting strap device 24 being fastened in a centre region of the bottom side 14. The two limiting strap devices 22, 24 are substantially identical in their shape, the central part 24a merely having an opening corresponding to the inflation opening 18.

In the region of the fastening of the central parts 22a, 24a of the limiting strap devices 22, 24 on the upper side 12 or respectively on the bottom side 14 of the gas bag 10, one or more reinforcement layers 26 can be provided respectively. Here, the fastening takes place by seams 28.

Each of the limiting strap devices 22, 24 has four band-shaped arms 22b, 24b originating symmetrically from the central part 22a, 24a, which terminate in end sections 22c, 24c. The distance from the centre of the central parts 22a, 24a to the end of the end sections 22c, 24c is shorter than the radius of the upper side 12 and, respectively, the bottom side 14 of the gas bag 10.

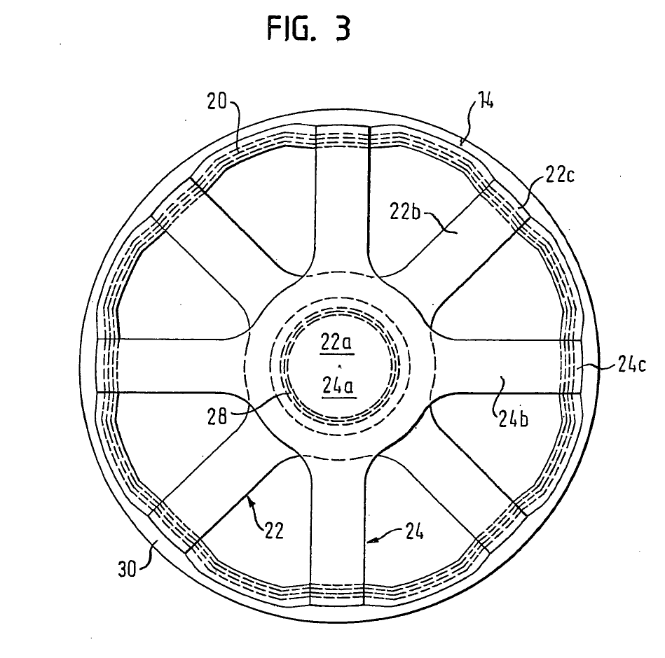

All end sections 22c, 24c of the limiting strap devices 22, 24 are connected by the peripheral fastening 20 with the upper side 12 and the bottom side 14 of the gas bag 10. The first limiting strap device 22 and the second limiting strap device 24 are turned peripherally through 45 degrees with respect to each other, as can be seen in FIG. 3. As a consequence, the end sections 22c and the end sections 24c engage, staggered with respect to each other, on the peripheral fastening 20. The peripheral angular distances between an end section 22c of the first limiting strap device 22 and an end section 24c of the second limiting strap device are respectively equal.

Through the limiting strap devices 22, 24, the peripheral fastening 20 is drawn towards the interior of the gas bag 10 during inflation of the gas bag 10. An indentation 30 encircling the gas bag 10 is formed in the region of the peripheral fastening 20. At the sites where the end sections 22c, 24c engage the peripheral fastening 20, the indentation 30 is slightly deepened.

Along the entire peripheral fastening 20 the indentation 30 is so deep, that the greatest lateral expansion l of the inflated gas bag 10 is formed in the radial direction r, perpendicular to its depth h, by sections 31 of the upper side 12 and the bottom side 14, respectively, whilst the peripheral fastening 20 and the bead, which is possibly formed, lie staggered thereto in direction towards the interior of the gas bag 10.

In the example shown here, the gas bag is manufactured by the limiting strap devices 22, 24 being placed between the upper side 12 and the bottom side 14, and the edge of the upper side 12 and the bottom side 14 being connected together with the end sections 22c and 24c of the limiting strap devices 22, 24 along the periphery of the upper side 12 and the bottom side 14 by means of seams, which form the peripheral fastening 20. Thereafter, the gas bag 10 is not turned inside out through the inflation opening 18, so that the edges of the upper side 12 and the bottom side 14 and also the peripheral fastening 20 remain on the outer side of the gas bag. As, with the gas bag being inflated, these edges and the peripheral fastening disappear, as it were, in the indentation 30, and are covered by regions 31 of the upper side 12 and the bottom side 14, a vehicle occupant does not get in contact therewith.

The traction forces F₂ acting on the gas bag 10 and especially on the peripheral fastening 20 are superimposed by the forces F₁ received by the limiting strap devices 22, 24. Hereby, a resultant force occurs, which is clearly directed into the interior of the gas bag 10.

This resultant force also remains when, as shown in FIG. 2, a vehicle occupant 16 immerses into the upper side 12 of the gas bag. Through the impact, the depth of the gas bag 10 reduces, so that its depth h′ is smaller than the depth h in the fully inflated state. Owing to the scissor effect of the limiting devices 22, 24, the gas bag yields in radial direction r, so that the lateral expansion l′ is greater than the lateral expansion l in the fully inflated state shown in FIG. 1. Through this change in shape, the volume of the gas bag 10 scarcely alters, and the internal pressure p of the gas bag remains to a certain extent constant.

As a majority of the effective traction forces are received by the limiting strap devices 22, 24 and not by the peripheral fastening 20, the latter is also relieved of stress at the moment of immersion of the vehicle occupant.

Even in the state shown in FIG. 2, the indentation 30 is maintained to such a measure that the peripheral fastening 20 is covered by the regions 31 of the upper side 12 and the bottom side 14, respectively.

Of course, a different number of arms 22b, 24b can also be used than that shown in FIG. 3.

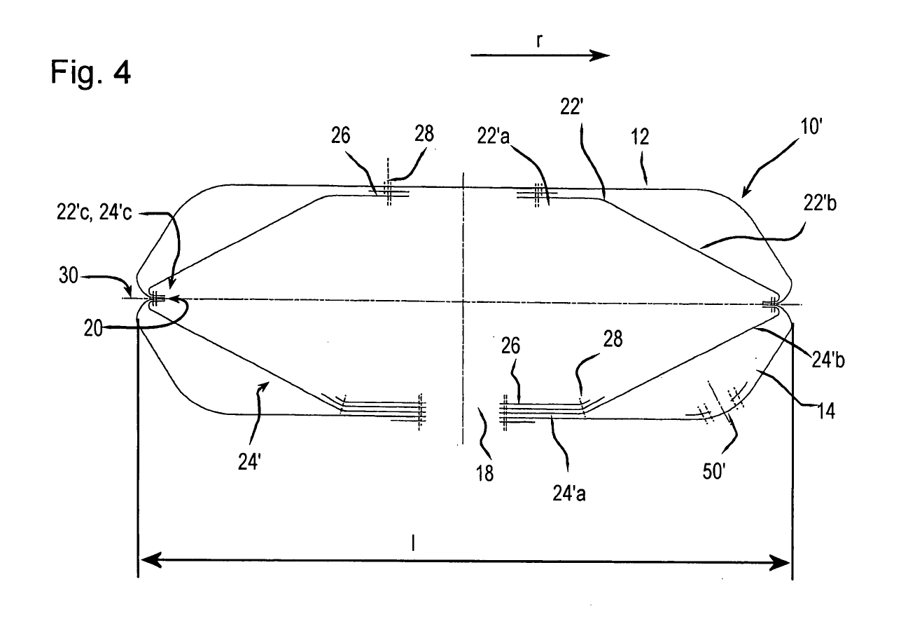

The embodiment shown in FIG. 4 is a variant of the above gas bag 10. In contrast thereto, the middle part 22′a of the limiting strap device 22′ is either ring-shaped, i.e. with an inner recess, or consists of several separate portions, the limiting strap device 22′ being arranged in the gas bag 10′ as described above. The central part 22′a is fixed to the upper side 12 of the gas bag 10′ via an additional reinforcement layer 26 lying between the upper side 12 of the gas bag 10′ and the central part 22′a. This is achieved by one or more seams 28. It is possible to attach the reinforcement layer 26 e.g. only at the upper side 12 of the gas bag 10′.

Optionally, an outflow opening 50′ is provided in the bottom side 14 of the gas bag 10′.

Contrary to the embodiment described above, the gas bag 10′ is sewn “inside out” and afterwards turned “right side up”, so that the peripheral fastening 20 is lying inside the gas bag 10′. The effects and advantages cited above remain, however, the same for this variant.

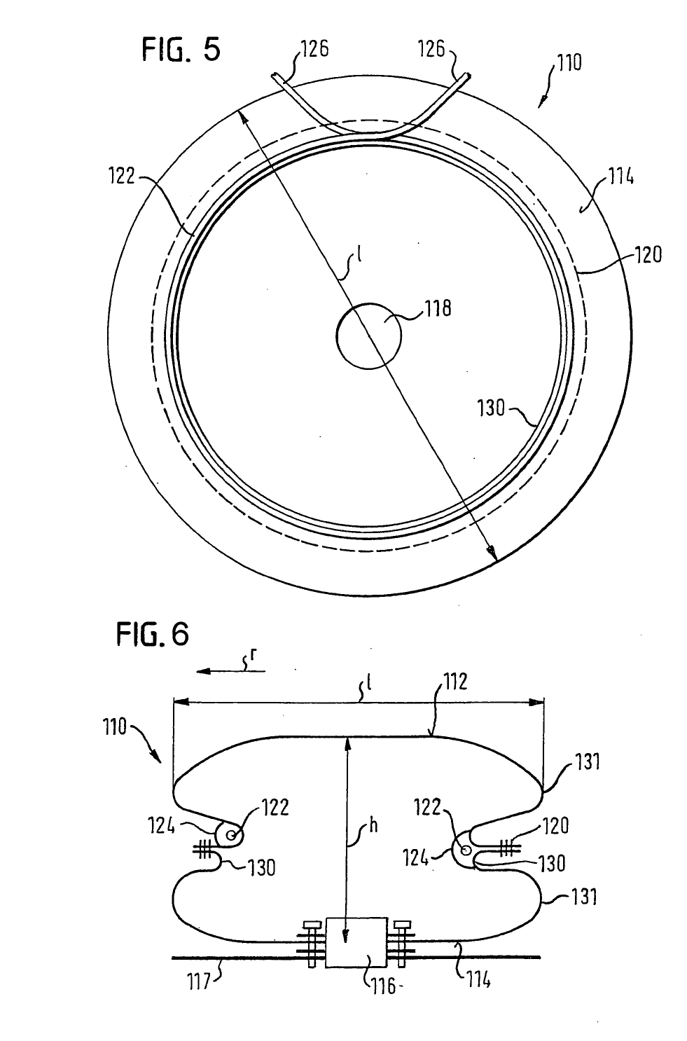

In the embodiment illustrated in FIGS. 5 to 7, the reduction of the stress of the peripheral fastening is achieved in a different way.

FIGS. 5 and 6 show a gas bag 110 with an upper side 112 and a bottom side 114 which, as in the previously described embodiment, each consist of a substantially circular fabric layer and which are fixed to each other along their peripheral edge by a peripheral fastening 120. The peripheral fastening 120 can consist, for example, of one or more seams or of a gluing of the edges of the upper side 112 and the bottom side 114 to each other.

In the centre of the bottom side 114, the gas bag 110 has an inflation opening 118 via which the gas bag is fastened in a known manner in a gas bag module with a gas generator 116 and a generator carrier 117, which are shown diagrammatically in FIG. 6.

In the region of the peripheral fastening 120, a ring-shaped reinforcing element 122 is arranged, which runs around, closed peripherally, the outer side of the gas bag in or close to the plane of the peripheral fastening 120. The reinforcing element 122 is, for example, a band or a cord.

In the variant shown on the left-hand side of FIG. 6, the reinforcing element 122 runs along the outer side of the gas bag 110 in one or more guides 124 which are connected to the wall of the gas bag 110. In the guide or guides 124, the reinforcing element 122 is held so that it can move relative to the guides 124 and relative to the gas bag wall.

In the variant shown in the right-hand half of FIG. 6, the reinforcing element 122 is arranged inside the gas bag 110, likewise running in one or more guides 124 which are connected to the wall of the gas bag 110. Here, the reinforcing element 122 is also displaceable relative to the guide or guides 124.

The guides 124 can be formed by a fabric layer, which is e.g. connected to the wall of the gas bag on one or both sides of the peripheral fastening.

The peripheral length of the ring-shaped reinforcing element 122, defined by the section of the reinforcing element 122 which constricts the gas bag 110, is shorter than the peripheral length of the peripheral fastening 120. This leads to the fact that in the fully inflated state, which is shown in FIGS. 5 and 6, the gas bag 110 is constricted in the region of the peripheral fastening 120 by the reinforcing element 122, so that in the region of the peripheral fastening 120 an indentation 130 directed radially inwards is formed. The extent of the indentation 130 into the interior of the gas bag is indicated in FIG. 5 by the circle lying inside the reinforcing element 122.

The indentation 130 is so deep, that the peripheral fastening 120 is drawn so far towards the central point of the gas bag 110, that it is covered by regions 131 of the upper side 112 and the bottom side 114, respectively. Therefore, a vehicle occupant does not get in contact with the peripheral fastening 120 or the edges of the upper side 112 or the bottom side 114 of the gas bag 110. This is even the case, when, as in the example shown here, the gas bag is sewn on the “right side”, so that the edges of the upper side 112 and the bottom side 114 and also the peripheral fastening 120 lie on the outer side of the gas bag. Both, in the fully inflated state as well as in the moment at which the vehicle occupant immerses into the gas bag 110, the greatest lateral expansion l of the gas bag 110 in radial direction r is greater than the diameter of the gas bag 110 in the region of the peripheral fastening 120, as is also illustrated in FIG. 5.

The reinforcing element 122 has only a small inherent elasticity, so that the indentation 130 of the gas bag 110 is always present. The stability of the reinforcing element 122 is selected so that even with the immersion of the occupant into the gas bag 110, the reinforcing element 122 does not tear or detach itself from the gas bag.

As the circumference of the reinforcing element 122 is smaller than the circumference of the peripheral fastening 120, a portion of the forces is received by the reinforcing element 122 and thus the stress onto the peripheral fastening 120 is reduced. Therefore, a widening of the seam stitches of the peripheral fastening 120, in case it is formed by a seam, is avoided.

The reinforcing element 122 can be formed simply by connecting the ends 126 of a cord or a band by knotting, sewing, gluing or another suitable way to form a ring, as is indicated in FIG. 5. Of course, the length of the ends 126 is not to be taken into consideration when the peripheral length of the reinforcing element 122 is considered.

Even if gas bags shown in the embodiments according to FIGS. 5 and 6 are sewn on the “right side”, the invention can nevertheless also be transferred for gas bags which are sewn inside out and then turned to the “right side”.

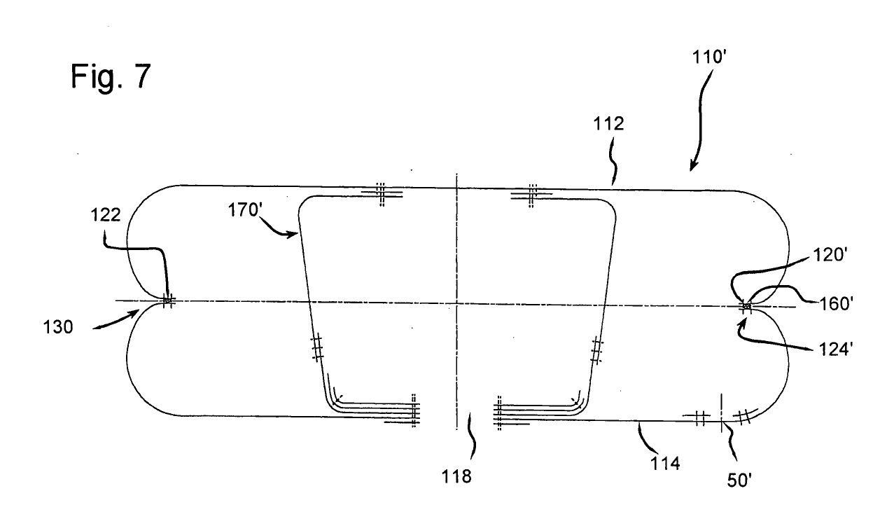

FIG. 7 shows a variant of the gas bag 110 discussed above. Similarly, the gas bag 110′ shown here is constricted in the plane of the peripheral fastening 120′ by a reinforcing element 122, so that the inflated gas bag 110′ has an indentation 130. The reinforcing element 122 runs in a guide 124′ formed between the peripheral fastening 120′ and a seam 160′. The seam 160′ is arranged radially inside or radially outside the peripheral fastening 120′ and can be circumferentially closed or only formed in segments. The reinforcing element 122 is movable inside the guide 124′ in relation to the gas bag 110′. Instead of the seam 160′ e.g. an adhesive connection is also usable.

The gas bag 110′ can also be provided with an outflow opening 50′.

Contrary to the variants shown in FIG. 6, the gas bag 110′ is sewn “inside out” and afterwards turned inside out to the “right side”, so that the peripheral fastening 120′ as well as the reinforcing element 122 are arranged on the inside of the gas bag 110′.

In addition to the indentation 130 achieved by the reinforcing element 122, the gas bag 110′ is provided with a limiting strap device 170′ extending between the bottom side 114 and the upper side 112 of the gas bag 110′. However, contrary to the first discussed embodiment, the limiting strap arrangement 170′ is not attached in the region of the peripheral fastening 120′, but only in the region of the inflation opening 118 and, opposite thereof, to the central portion of the upper side 112. The limiting strap device 170′ may consist of two separate elements, each possessing several arms, the arms of the individual elements being connected via seams.

The embodiments according to FIGS. 1 to 3 can also be combined with those according to FIGS. 5 to 7.

Neither the limiting strap devices 22, 24, 22′, 24′ nor the reinforcing elements 122, 122′ tear or elongate during the inflation of the gas bag 10, 10′, 110, 110′ or on immersion of the vehicle occupant into the gas bag.

1. A gas bag for a vehicle occupant restraint system,
having an upper side (12) and a bottom side (14),
said upper side (12) and said bottom side (14) being connected with each other along a peripheral fastening (20),
and a first and a second limiting strap device (22, 24; 22′, 24′) arranged inside said gas bag (10), said limiting strap devices (22, 24; 22′, 24′) having a central part (22a, 24a; 22′a, 24′a) and several end sections (22c, 24c; 22′c, 24′c),
said central part (22a; 22′a) of said first limiting strap device (22; 22′) being connected to said upper side (12) of said gas bag (10),
said central part (24a; 24′a) of said second limiting strap device (24; 24′) being connected to said bottom side (14) of said gas bag (10) and
said end sections (22c, 24c; 22′c, 24′c) of said limiting strap devices (22, 24; 22′, 24′) being connected to said peripheral fastening (20), and
said limiting strap devices (22, 24; 22′, 24′) being coordinated with respect to length and arrangement, so that said gas bag (10) in a fully inflated state is constricted by said limiting strap devices in a region of said peripheral fastening (20).

2. The gas bag according to claim 1, wherein in said region of said peripheral fastening (20) an indentation (30) is formed, which is so deep that regions (31) of said upper side (12) project further in a radial direction (r) than said peripheral fastening (20).

3. The gas bag according to claim 1, wherein said end sections (22c, 24c; 22′c, 24′c) of said first and second limiting strap devices (22, 24; 22′, 24′) engage on said peripheral fastening (20), staggered with respect to each other peripherally.

4. The gas bag according to claim 1, wherein said end sections (22c, 24c; 22′c, 24′c) of said limiting strap devices (22, 24; 22′, 24′) are arranged peripherally with equal angular distances on said peripheral fastening (20).

5. The gas bag according to claim 1, wherein at least one of said first and said second limiting strap devices (22, 24; 22′, 24′) is formed in a single piece.

6. The gas bag according to claim 1, wherein at least one of said first and said second limiting strap devices (22, 24; 22′, 24′) consists of a fabric layer.

7. A gas bag for a vehicle occupant restraint system,
having an upper side (112) and a bottom side (114),
said upper side (112) and said bottom side (114) being connected with each other along a peripheral fastening (120; 120′),
and a reinforcing element (122) encircling said gas bag peripherally, said reinforcing element (122) being arranged in a region of said peripheral fastening (120; 120′),
a peripheral length of said reinforcing element (122) being shorter than a peripheral length of said peripheral fastening (120; 120′), so that said gas bag (110; 110′) in a fully inflated state is constricted by said reinforcing element (122) in said region of said peripheral fastening (120; 120′).

8. The gas bag according to claim 7, wherein in said region of said peripheral fastening (120; 120′) an indentation (130) is formed, which is so deep that regions (131) of said upper side (112) project further in a radial direction (r) than said peripheral fastening (120; 120′).

9. The gas bag according to claim 7, wherein said reinforcing element (122) is arranged inside said gas bag (110).

10. The gas bag according to claim 7, wherein said reinforcing element (122) is arranged on an outer side of said gas bag (110).

11. The gas bag according to claim 7, wherein said reinforcing element (122) is a cord or a band.

12. The gas bag according to claim 7, wherein said reinforcing element (122) runs in a guide (124; 124′).
